(19) United States
(12) Patent Application Publication
(10) Pub. No.: US 2009/0200282 A1
(43) Pub. Date: Aug. 13, 2009

(54) WELD SIGNATURE MONITORING METHOD AND APPARATUS

(75) Inventor: Jay Hampton, Lenox, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/028,431

(22) Filed: Feb. 8, 2008

(51) Int. Cl. B23K 9/095; G01M 19/00

(52) U.S. Cl. 219/130.33; 219/130.01; 73/865.8

(57) ABSTRACT

A method monitors a weld signature of a welding apparatus by processing the signature through a neural network to recognize a pattern, and by classifying the weld signature in response to the pattern. The method determines if the weld signature is sufficiently different from training weld signatures stored in a database, and records the weld signature in the database when sufficiently different. The method tests a weld joint to determine values of different weld joint properties, and then correlates the signature with the weld data to validate the database. An apparatus monitors a weld signature during a welding process to predict welding joint quality, and includes a welding gun, a power supply, and a sensor for detecting welding voltage, current, and wire feed speed (WFS). A neural network receives the welding process values and classifies the signature into different weld classifications each corresponding to a predicted welding joint quality.

### TECHNICAL FIELD

The invention relates generally to a method and apparatus for monitoring a weld signature during a welding process by classifying the weld signature using a neural network model or a neural processor.

### BACKGROUND OF THE INVENTION

Welding systems are utilized extensively in various manufacturing processes to join or bond various work surfaces. Arc welding systems in particular may be used to strongly fuse or merge separate work surfaces into a unified body via the controlled application of intense heat and an intermediate material to form a resultant weld joint. A strong metallurgical bond forms when the intermediate material, which is quickly rendered molten in the presence of a high temperature arc during the arc welding process, ultimately cools and solidifies. Ideally, the resultant weld joint has approximately the same overall strength and other material properties as the originally separate work surfaces.

In an arc welding process, the arc may be formed between the work surface and a consumable electrode, such as length of wire, which is controllably fed to a welding gun while the welding gun moves along the welding joint, with the arc being transmitted via an ionized column of arc shielding gas. The arc itself provides the intense levels of heat necessary for melting the consumable electrode or wire. The electrode thus conducts electrical current between the tip of the welding gun and the work surface, with the molten wire material acting as a filler material when supplied to the weld joint.

The quality of a particular weld joint may be determined using destructive testing, i.e. by physically breaking or cutting the weld joint under controlled conditions to precisely measure the strength and/or the overall integrity of the weld joint. However, monitoring the welding process in real time in order to accurately detect an acceptable, “passing”, or a “good” weld can be a challenging process due to the substantial number of different welding system and environmental operating variables that interrelate in a complex manner to influence the resultant weld quality. Algorithmically comparing the various individual welding system variables to stored thresholds can also be less than optimal due to the difficulty in precisely determining an isolated or individual contribution or effect of variance in a particular variable value on the overall quality of a resultant weld joint.

### SUMMARY OF THE INVENTION

Accordingly, a method for monitoring a weld signature of a welding apparatus includes determining the weld signature, processing the signature through a neural network to thereby recognize a pattern presented by the weld signature, and classifying the weld signature into one of a plurality of different classifications in response to the pattern that is recognized by the neural network.

In one aspect of the invention, determining the weld signature includes measuring a welding voltage, a welding current, and a wire feed speed (WFS) used by the welding apparatus.

In another aspect of the invention, determining the weld signature further includes recording a composition of a shielding gas used in the welding process.

In another aspect of the invention, classifying the weld signature further includes activating a notification device in one manner when the weld signature is classified as a first weld classification, and in another manner when the weld signature is classified as a second weld classification.

In another aspect of the invention, the method includes determining if the weld signature is sufficiently different from each of a plurality of training weld signatures that are stored in a training database, and recording the weld signature in the training database when the weld signature is determined to be sufficiently different from each of the plurality of training weld signatures.

In another aspect of the invention, a method for monitoring a weld signature during an arc welding process includes determining a plurality of different welding process variables defining the weld signature, including at least a welding voltage, a welding current, and a wire feed speed (WFS). The method includes classifying the weld signature into one of a plurality of different weld classifications using a neural network. The neural network has a plurality of input nodes each corresponding to a different one of the welding process variables. Classifying the weld signature is characterized by an absence of a comparison of any one of the different welding process variables to a corresponding threshold value.

In another aspect of the invention, the method compares the weld signature to a database of training weld signatures after the weld signature is classified, determines if the weld signature is sufficiently different from each of the training weld signatures in the database, and records the weld signature in the database when the weld signature is determined by the neural network to be sufficiently different from each of the training weld signatures.

In another aspect of the invention, the method tests a weld joint after classifying to determine a set of weld data containing the values of each of a plurality of different weld joint properties, and then correlates the weld signature with the set of weld data to validate the database.

In another aspect of the invention, an apparatus is provided for monitoring a weld signature during a welding process to thereby predict a quality of a welding joint. The apparatus includes a welding gun operable for forming a weld joint, a power supply configured for supplying a welding voltage and a welding current for selectively powering the welding gun, and a sensor for detecting values of a plurality of different welding process values, including the welding voltage, welding current, and a wire feed speed (WFS). The apparatus includes a controller having a neural network adapted for receiving the welding process values and classifying the weld signature into a plurality of different weld classifications each corresponding to a different predicted quality of the welding joint.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a welding apparatus and a controller operable for monitoring a weld signature according to the invention;

FIG. 2 is a graphical representation of a representative acceptable or “passing” weld signature;

FIG. 3 is a graphical representation of a representative unacceptable or “failing” weld signature;

FIG. 4 is a graphical representation of an artificial neuron model or neural network usable with the controller shown in FIG. 1; and

FIG. 5 is a graphical flow chart describing a method for monitoring a weld signature.

### DESCRIPTION OF THE PREFERRED EMBODIMENTS

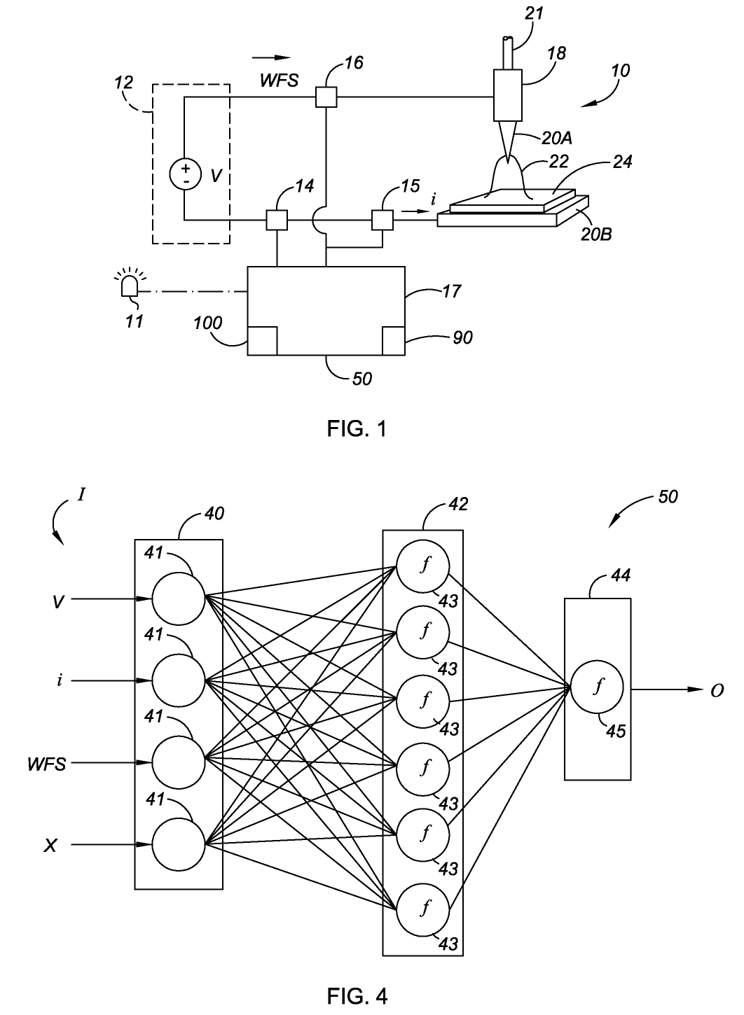

Referring to the drawings, wherein like reference numbers correspond to like or similar components throughout the several figures, and beginning with FIG. 1, an apparatus and method for monitoring a weld signature of a welding process is provided herein, which may be used in a variety of different welding processes, including but not limited to single work piece operations, joining two or more work pieces or surfaces together, and/or for joining two ends of a single work piece together. Accordingly, a welding apparatus 10 includes an automated or manual welding device or welding gun 18, which is operatively connected to an integrated control unit or controller 17 and a power supply 12 providing a voltage, represented in FIG. 1 as the variable “V”. A plurality of sensors 14, 15, and 16, which may alternately be configured as a single sensor and/or housed together in a common sensor housing (not shown), are adapted for sensing, measuring, detecting, and/or otherwise determining the values over time of one or more dynamically changing welding process variables, which together define the “weld signature”, as will be described in detail hereinbelow.

The weld gun 18 is configured for selectively completing a welding operation, such as but not limited to metal inert gas (MIG) or tungsten (TIG) arc welding, at one or more weld points or joints on or along one or more work pieces 24. The weld gun 18 may be mounted to a manual or robotic arm 21 in a repositionable and re-orientable manner, such as by selective pivoting and/or rotation. The welding apparatus 10 includes at least one electrode 20A, which may be a portion of a nozzle of the weld gun 18 as shown, and an electrode 20B, shown as a plate on which the work piece 24 is positioned, with the electrodes 20A, 20B positioned generally opposite one another when the weld gun 18 is active or generating a high-temperature arc 22. The controller 17 includes a neural network 50 (also see FIG. 4), a training signature database 90, and an adaptive weld monitoring or classifying method 100 for using the neural network 50 and the training signature database 90 for monitoring and ultimately classifying a weld signature in real-time during a welding process.

In accordance with the invention, the method 100 utilizes the neural network 50 (also see FIG. 4) as an information processing paradigm, which is able to look, in real-time, at a total or combined set of detectable or measurable welding process variables, collectively referred to hereinafter as the weld signature, and to determine or recognize whether a particular pattern represented by the weld signature is acceptable, good, or passing, or unacceptable, bad, or failing, according to a predetermined set of weld quality criteria. The neural network 50 is initially trained during a controlled training process, for example by subjecting the neural network 50 to a plurality of training weld signatures each corresponding to an acceptable weld signature according to the predetermined set of weld quality criteria, as will be understood by those of ordinary skill in the art. The neural network 50 is also continuously trainable by exposing the neural network 50 to additional acceptable weld signatures over time to further develop and refine the pattern-recognition and weld signature classifying accuracy of the neural network 50, as will be described below.

As will be understood by those of ordinary skill in the art, neural networks such as the neural network 50 may be used to predict a particular result and/or to recognize a pattern that is presented by less than optimal, imprecise, and/or relatively complex set of input data. For example, such a complex set of input data set may consist of the more typical welding process variables, i.e. the welding voltage V, the welding current i, and the wire feed speed (WFS) as described above, and/or other such dynamically changing input variables, as will be described later below with reference to FIG. 4.

Neural networks are also operable for adapting or “learning” via repeated exposure to different training sets, such as any supervised or unsupervised input data sets, and are operable for dynamically assigning appropriate weights and/or relative significance values to each of the various different pieces of information constituting the input data set. Neural networks are generally not pre-programmed to perform a specific task, such as with various control algorithms that utilize a preset max/min threshold limit for each distinct value without in any way predicting or classifying the total or overall monitored weld signature. Instead, neural networks, such as the neural network 50 of FIGS. 1 and 4, utilize associative memory to effectively generalize about the totality or universe of the combined input set to which the neural network is subjected, such as the welding system input set “I” shown in FIG. 4. In this manner, a properly trained neural network may be able to accurately and consistently predict a future condition from past experience, classify a complex data set as required, as represented by the arrow O in FIG. 4, and/or recognize an overall pattern presented by the totality of the complex data set, which might otherwise require substantial time and/or expertise to properly decipher.

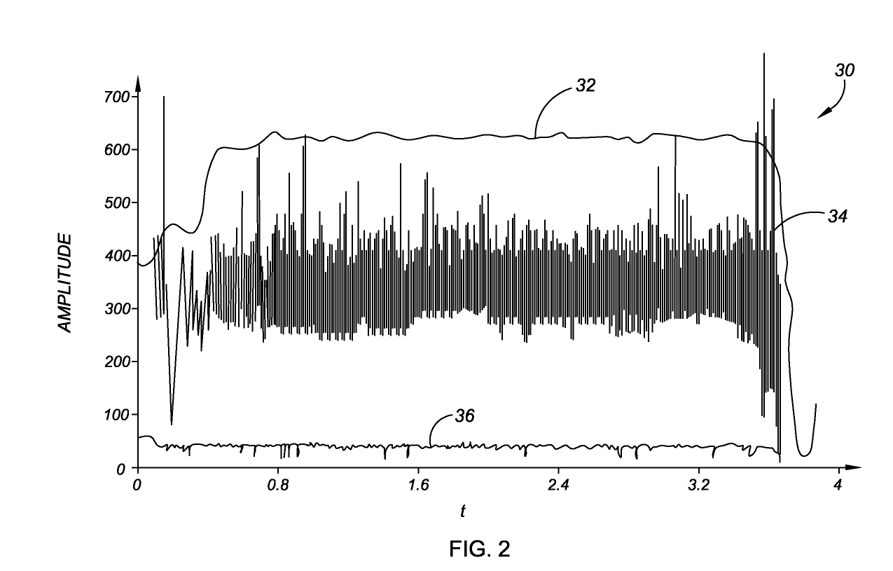

Referring to FIG. 2, such a complex input data set described above may be embodied herein as a weld signature 30. The weld signature 30, which in FIG. 2 represents a typical passing, good, or otherwise acceptable weld signature, i.e. a weld signature that has been validated in some manner as producing a resultant weld joint (not shown) meeting predetermined subjective and/or objective strength, quality, uniformity, and/or other such criteria. The weld signature 30 itself represents the values over a duration of time of at least three distinct variables, i.e., the wire feed speed (WFS), the welding voltage V, and the welding current i, each of which has a corresponding trace as shown in FIG. 2. That is, the trace 32 represents the wire feed speed (WFS) as described above, which may be measured or detected in proximity to the weld gun 18 (see FIG. 1) using the sensor 16 (see FIG. 1). The trace 34 represents the welding current i at or near the weld gun 18 as measured by the sensor 15 (see FIG. 1), with the variations in the welding current (trace 34) correlating with any variations in wire feed speed (WFS), as will be understood by those of ordinary skill in the art. The trace 36 represents the measured voltage at or near the weld gun 18 using the sensor 14 (see FIG. 1).

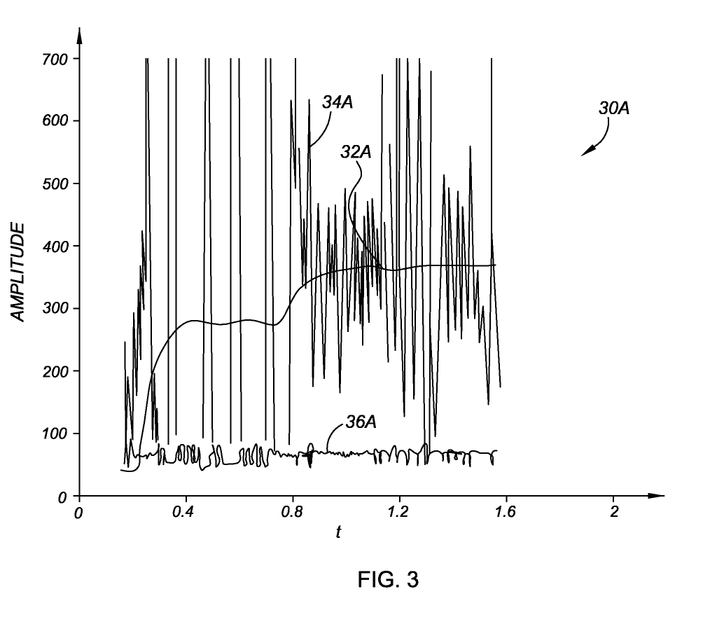

Referring to FIG. 3, a representative failing or otherwise unacceptable weld signature 30A, i.e., a weld signature producing a weld joint (not shown) that does not meet predetermined subjective and/or objective strength, quality, uniformity, or other criteria. The weld signature 30A contains the values over time of the same three distinct variables described above, i.e., wire feed speed (WFS), voltage, and current. The trace 32A represents the wire feed speed (WFS) as described above. The trace 34A represents the measured current, with the variations in current (trace 34A) correlating with any variations in wire feed speed (WFS), as will be understood by those of ordinary skill in the art. The trace 36A likewise represents the measured voltage at or near the weld gun 18 using the sensor 14 (see FIG. 1). The weld signatures 30, 30A of FIGS. 2 and 3, respectively, are representative, with the actual weld signatures used to populate a given training signature database 90 (see FIG. 1) varying depending on the welding process and weld joint quality criteria.

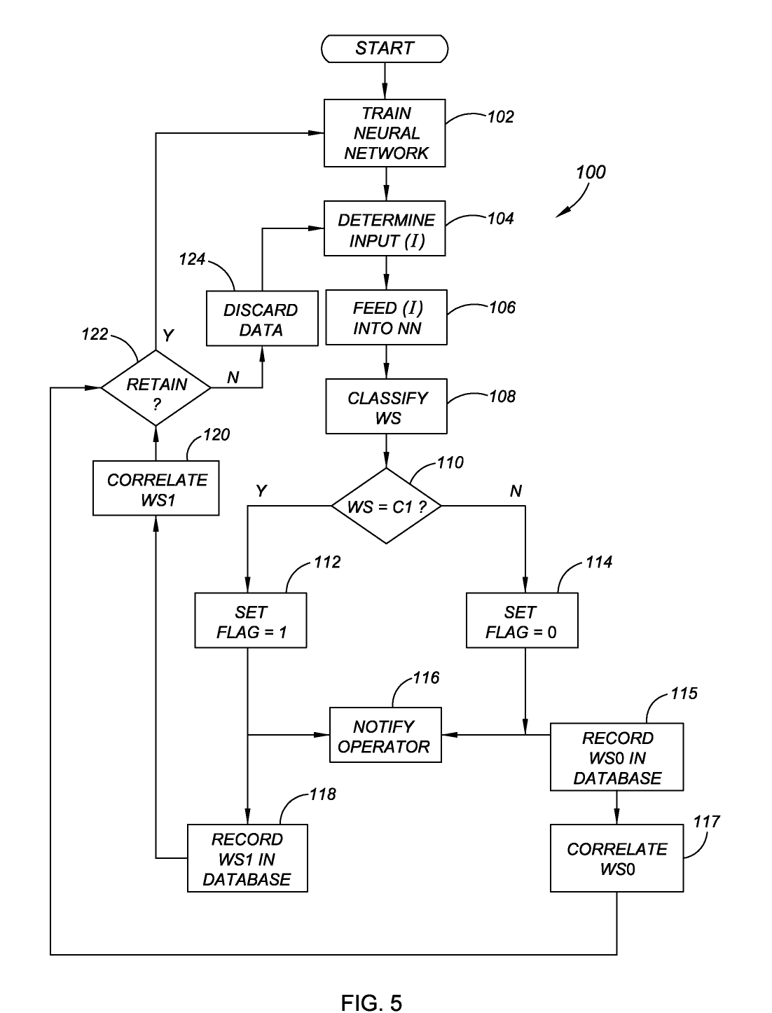

Referring to FIG. 4, the neural network 50 described generally above is programmed, stored in, or otherwise accessible by the controller 17 (see FIG. 1), and is usable by the algorithm 100 (see FIGS. 1 and 5) to accurately predict, classify, or otherwise recognize a pattern in an instantaneous weld signature. The neural network 50 includes at least one input layer 40 having a plurality of different input neurons or input nodes 41, each of which are configured to receive data, measurements, and/or other predetermined information from outside of the neural network 50. As shown in FIG. 4, in one embodiment this information or input set I includes, but is not limited to, the welding voltage V, the welding current i, and the wire feed speed or WFS, each of which is also shown in FIG. 1. At least one additional input node 41 may be configured to receive an additional piece of input data, a measurement, or other process information as needed, as represented by the variable X. For example, the input variable X may correspond to a particular composition of arc shielding gas used in an arc welding process.

The neural network 50 further includes at least one “hidden” layer 42 containing a plurality of hidden neurons or hidden nodes 43 that each receive and pass along information that is output from the input nodes 41 of the input layer 40, with the hidden nodes 43 passing along the processed information to other neurons or nodes of one or more additional hidden layers (not shown) if used, or directly to an output layer 44. The output layer 44 likewise contains at least one output neuron or output node 45 that communicates or transmits information outside of the neural network 50, such as to the indicator device 11 (see FIG. 1) and/or to the training database 90 (see FIG. 1) as determined by the algorithm 100, which is described below with reference to FIG. 5.

In the representative embodiment of FIG. 4, each of the neurons or nodes 43, 45 of the hidden layer 42 and the output layer 44, respectively, may employ a tan-sigmoidal transfer or activation function as shown, but may alternately employ a linear activation function and/or other types of sigmoidal or other activation functions as desired, and/or different numbers of hidden layers 42 and/or nodes 43, 44, in order to achieve the desired level of predictive accuracy depending on the particular output (arrow O) required. In one embodiment, the neural network 50 is initially trained using the known Levenberg-Marquardt back-propagation algorithm, but training is not so limited, with any other suitable training method or algorithm being usable with the invention.

Referring to FIG. 5, the method 100 (also see FIG. 1) of the invention may be programmed, stored, recorded, or is otherwise executable by the controller 17 (see FIG. 1), and begins with step 102. Step 102 includes at least a preliminary training process, as that term will be understood by those of ordinary skill in the art, wherein the neural network 50 of FIG. 4 is trained to accurately recognize a passing, good, or otherwise acceptable weld signature. An acceptable weld signature may be any weld signature corresponding to a validated weld joint, i.e. a weld joint meeting a predetermined set of criteria for quality, strength, uniformity, and/or other desirable properties or qualities, as described above. Step 102 may be conducted by exposing or subjecting the neural network 50 of FIG. 4 to a number of sufficiently different or varied acceptable weld signatures, such as is represented in FIG. 2. Generally, the greater the number of training data sets presented to a neural network, and the greater the variety of these data sets from one another, the more accurate the classification or pattern recognition by, and/or predictive value of, of the neural network. After properly training the neural network 50 in this manner, the method 100 proceeds to step 104.

At step 104, the method 100 measures, detects, or otherwise determines values for each of the variables comprising the input data set I of FIG. 4, such as but not limited to the welding voltage V, the welding current i, and the wire feed speed (WFS), as well as variable X (see FIG. 4) such as a particular shielding gas composition, and then continuously monitors these values for the duration required for completing a particular weld joint. The values at step 104 may be determined using the sensors 14, 15, and 16 of FIG. 1. Once these values are properly determined at step 104, the method 100 proceeds to step 106.

At step 106, the input data set I (see FIG. 4) from step 104 is fed or directed into the input layer 40 of the neural network 50 also as shown FIG. 4. The neural network 50 then dynamically assigns weights to the various variables comprising the input data set I, and references any associated data matrices and/or training sets of the training database 90 (see FIG. 1) that might be used by the neural network 50, to thereby process the instantaneous weld signal, abbreviated WS for simplicity in FIG. 5. The method 100 then proceeds to step 108.

At step 108, the neural network 50 classifies the weld signal (WS) in one of a plurality of different weld categories or classifications. For example, the output (arrow O of FIG. 4) from the output layer 44 of the neural network 50 that is shown in FIG. 4 may be normalized, i.e. assigned a value between −1 and 1, such as by using a tan-sigmoidal or other transfer function or activation function at the output node 45 (see FIG. 4) as described above. Values falling between −1 and 0 may be selected to correspond to an unacceptable or failing weld signature, while values falling between 0 and 1 may be classified as an acceptable or passing weld signature.

Within these respective classifications, the corresponding normalized values of which may be changed as desired depending on user preferences, a normalized value more closely approaching a minimum value, i.e. −1, may be considered as a more undesirable weld than, for example, would a weld signature having a normalized value of −0.1, while a normalized value more closely approaching 1 may be classified as a more desirable or acceptable weld than, for example, would a weld signature having a normalized value of 0.1. Likewise, a value of 0 may indicate a weld signature that is equally acceptable and unacceptable according to the neural network 50 (see FIG. 4), potentially requiring further determination, testing, weld validation, and/or other analysis for proper classification. After classifying the weld signature (WS), the method 100 then proceeds to step 110.

At step 110, the method 100 determines whether the weld signature (WS) classified at step 108 is equal to a first category or classification representing an acceptable weld signature, with this classification being abbreviated C1 in FIG. 5 for simplicity. If the classification of the weld signature (WS) falls within the classification C1, the method 100 proceeds to step 112, with the method 100 otherwise proceeding to step 114.

At step 112, the method 100 may set a flag or other suitable marker within the controller 17 (see FIG. 1) equal to an integer value corresponding to or identifying the classification, such as 1, or to any other value corresponding to a positive or passing classification as determined at step 110. The method 100 then proceeds to steps 116 and 118.

At step 114, having determined at step 110 that the classification of the weld signature (WS) is not equal to the value assigned at step 112, for example 1, the method 100 sets a flag or other marker within the controller 17 (see FIG. 1) equal to 0, or to any other value corresponding to a negative or failing classification as determined at step 110. The method 100 then proceeds to steps 115 and 116.

At step 115, having set a flag at step 114 indicating a negative, unacceptable, or otherwise failing instantaneous weld signature (WS0), the method 100 temporarily records the weld signature (WS0) within the controller 17 for possible future use as a training set. The method 100 then proceeds to step 117.

At step 116, the method 100 may selectively activate a notification device 11 (see FIG. 1) to visually or audibly alert an operator as to the classification of the weld signature (WS) determined by the neural network 50 (see FIG. 4), such as by activating a notification device 11 (see FIG. 1) in proximity to the operator. For example, when a normalized value of a classification falls between −1 and 0, the notification device 11 may illuminate in one color, such as red, indicating an unacceptable weld signature (WS0), and/or sound a readily identifiable audible alarm.

Likewise, the notification device 11 may illuminate in another color, such as green, when a normalized value of the classification falls between a predetermined range, such as 1 and 0.5, or any predetermined range corresponding to a weld signature (WS) predicted by the neural network 50 (see FIG. 4) as having a particularly strong probability of having a high strength/quality weld. Normalized values falling between another predetermined range, such as 0 and 0.5, may illuminate in yet another color, such as amber, indicating that the classified weld signature (WS) may be approaching an unacceptable level, requiring further process control and/or analysis. An operator that is notified of a weld signature recognized by the neural network 30 (see FIG. 1) as failing may be expected to take immediate action to stop and/or take corrective action, so the method 100 may conclude at step 116 when a weld signature is classified as unacceptable.

At step 117, the method 100 correlates the temporarily stored unacceptable weld signature (WS0) to a set of weld data to determine whether the weld signature (WS) has been properly classified. For example, a weld joint (not shown) may be selected and destructively tested in order to determine whether the weld joint lacks the required strength, uniformity, and/or other desired properties as predicted by the neural network 50 (see FIG. 4) in classifying the weld signature (WS0) as unacceptable or failing. Alternately, or concurrently, the method 100 may correlate the instantaneous weld signature (WS0) to each of the weld signatures stored in the training signature database 90 (see FIG. 1), and determines if the weld signature (WS0) recently classified as unacceptable is sufficiently different from each of the weld signatures contained in the training database 90 of FIG. 1. The method 100 then proceeds to step 122.

At step 118, having set a flag to 1 at step 112 indicating a positive or passing weld classification, the method 100 temporarily records the weld signature (WS1) within the controller 17 for possible future use as a training set. The method 100 then proceeds to step 120.

At step 120, the method 100 correlates the temporarily stored weld signature (WS1) to asset of weld data to determine whether the weld signature (WS1) has been properly classified. For example, a weld joint (not shown) may be selected and destructively tested in order to determine whether the weld joint has the required strength, uniformity, and/or other desired properties as predicted by the neural network 50 (see FIG. 4) in classifying the acceptable weld signature (WS1). Alternately, or concurrently, the method 100 may correlate the weld signature (WS1) to each of the weld signatures stored in the training signature database 90 (see FIG. 1), and determines if the weld signature (WS) recently classified as acceptable is sufficiently different from each of the weld signatures contained in the training signature database 90 of FIG. 1. The method 100 then proceeds to step 122.

At step 122, the method 100 determines whether or not to retain the acceptable weld signature (WS1) recorded at step 118 in light of the results of step 120. If the weld signature (WS1) is sufficiently different from each of the stored weld signatures in the training signature database 90 (see FIG. 1), the method 100 determines that the weld signature (WS1) possesses sufficient value as a training weld signature to warrant addition to the training signature database 90 (see FIG. 1). The method 100 repeats to step 102, and proceeds to train the neural network 50 of FIG. 4 by exposing the neural network 50 to the weld signature (WS1) recorded at step 118, thus adding the weld signature (WS1) to the training signature database 90 (see FIG. 1). Otherwise, the method 100 proceeds to step 124.

At step 124, the method 100 discards the weld signature (WS1) that was temporarily recorded at step 118, and repeats step 104 as described above.

While the best mode for carrying out the invention have been described in detail, those familiar with the art to which this invention relates will recognize various alternative designs and embodiments for practicing the invention within the scope of the appended claims.

1. A method for monitoring a weld signature of a welding apparatus, the method comprising:
determining the weld signature;
recognizing a pattern presented by the weld signature using a neural network; and
classifying the weld signature into one of a plurality of different classifications in response to the pattern that is recognized by said neural network.

2. The method of claim 1, wherein said determining the weld signature includes measuring a welding voltage, a welding current, and a wire feed speed (WFS) used by the welding apparatus.

3. The method of claim 2, wherein said determining a weld signature further includes recording a composition of a shielding gas used in the welding process.

4. The method of claim 1, wherein said classifying the weld signature further includes activating a notification device in one manner when the weld signature is classified as a first one of said different weld classifications, and in another manner when the weld signature is classified as a second one of said different weld classifications.

5. The method of claim 1, further comprising:
determining if the weld signature is sufficiently different from each of a plurality of training weld signatures that are stored in a training database; and
recording the weld signature in said training database when the weld signature is determined to be sufficiently different from each of said plurality of training weld signatures.

6. The method of claim 5, further comprising:
discarding the weld signature when the weld signature is determined to be insufficiently different from each of said plurality of training weld signatures.

7. A method for monitoring a weld signature during an arc welding process comprising:
determining a plurality of different welding process variables defining the weld signature, including at least a welding voltage, a welding current, and a wire feed speed (WFS); and
classifying the weld signature into one of a plurality of different weld classifications using a neural network, said neural network having a plurality of input nodes each corresponding to a different one of said plurality of different welding process variables;
wherein said classifying the weld signature is characterized by an absence of a comparison of any one of said plurality of different welding process variables to a corresponding threshold value.

8. The method of claim 7, further comprising:
activating a notification device in one manner when the weld signature is classified as a first one of said different weld classifications, and in another manner when the weld signature is classified as a second one of said different weld classifications.

9. The method of claim 8, further comprising:
comparing the weld signature to a database of training weld signatures after the weld signature is classified;
determining if the weld signature is sufficiently different from each of said training weld signatures in said database; and
recording the weld signature in said database when the weld signature is determined to be sufficiently different from each of said training weld signatures.

10. The method of claim 9, further comprising:
testing a weld joint after said classifying to thereby determine a set of weld data containing the values of each of a plurality of different weld joint properties; and
correlating the weld signature with said set of weld data to thereby validate said database.

11. An apparatus for monitoring a weld signature during a welding process to thereby predict a quality of a welding joint, the apparatus comprising:
a welding gun operable for forming a weld joint;
a power supply configured for supplying a welding voltage and a welding current for selectively powering said welding gun;
at least one sensor for detecting values of a plurality of different welding process values, including said welding voltage, said welding current, and a wire feed speed (WFS) corresponding to a speed of a length of welding wire that is consumable in the formation of the welding joint; and
a controller having a neural network adapted for receiving said plurality of welding process values and for classifying the weld signature into a plurality of different weld classifications each corresponding to a different predicted quality of the welding joint.

12. The apparatus of claim 11, wherein said controller is operable for selectively activating an indicator device in one manner when the weld signature is classified as a first one of said different weld classifications, and in another manner when the weld signature is classified as a second one of said different weld classifications.

13. The apparatus of claim 12, wherein said controller includes a database containing a plurality of training weld signatures each corresponding to a welding joint having an acceptable weld quality.
